(19) United States
(12) Patent Application Publication
(10) Pub. No.: US 2025/0391336 A1
(43) Pub. Date: Dec. 25, 2025

(54) DISPLAY DEVICE AND METHOD OF DRIVING DISPLAY DEVICE

(71) Applicant: Samsung Display Co., Ltd., Yongin-si (KR)

(72) Inventors: Byeong Doo KANG, Yongin-si (KR); Jae Woo RYU, Yongin-si (KR); Yoon Ju KIM, Yongin-si (KR); Sung Mo YANG, Yongin-si (KR)

(21) Appl. No.: 19/205,695

(22) Filed: May 12, 2025

(30) Foreign Application Priority Data
Jun. 20, 2024 (KR) 10-2024-0079995
Aug. 7, 2024 (KR) 10-2024-0105622

(51) Int. Cl. G09G 3/32; G09G 3/3225

(52) U.S. Cl. CPC G09G 3/32; G09G 3/3225; G09G 2300/0842; G09G 2330/023

(57) ABSTRACT

A display device includes a processor configured to output image data, a display module configured to display an image based on the image data, a first memory configured to store data generated during operation of the display module, and a second memory, wherein the processor is further configured to provide a power-off notification (PON) command to the first memory while the display module displays the image, wherein the first memory is configured to be initialized upon power-on, and is configured to organize internal data in response to the PON, and wherein the second memory is configured to store performance result information indicating whether the first memory organized the internal data.

### CROSS-REFERENCE TO RELATED PATENT APPLICATION

The present application claims priority to, and the benefit of, Korean Patent Application Number 10-2024-0079995, filed on Jun. 20, 2024, and Korean Patent Application Number 10-2024-0105622, filed on Aug. 7, 2024, in the Korean Intellectual Property Office, the entire disclosures of which are incorporated herein by reference.

### BACKGROUND

### 1. Field

Embodiments of the present disclosure relate to a display device, and to a method of driving a display device.

### 2. Description of the Related Art

A display device displays an image using pixels including light-emitting elements. If the light-emitting element is implemented as an organic light-emitting diode, the light-emitting element is degraded by use, and the degraded light-emitting element (or a pixel including it) emits light at a luminance lower than a target luminance.

The display device acquires an amount of usage of pixels and compensates for gradation values (or image data) based on the amount of usage (or degradation). This allows the pixels to emit at the target luminance.

### SUMMARY

The amount of usage of pixels is stored in a memory. When a display device is powered on, the memory is initialized, but the initialization time of the memory changes randomly depending on the level of memory usage, and a stable boot time of the display device cannot not secured.

The present disclosure provides a display device, and a method of driving the display device capable of securing the stable boot time.

Aspects of the present disclosure are not limited to the aspects mentioned above, and other aspects not mentioned may be clearly understood by a person skilled in the art from the following description.

A method of driving a display device according to embodiments of the present disclosure is performed for the display device including a display panel, a processor, and a first memory. The method of driving the display device includes initializing the first memory upon power-on, and periodically storing data generated during operation of the display panel in the first memory by storing the data in the first memory, organizing the data in the first memory by providing a power-off notification (PON) command to the first memory, and periodically repeating the storing of the data and the organizing of the data.

The first memory may include an embedded MultiMedia Card (eMMC).

The method may further include periodically storing, in the first memory, accumulated data indicating driving time of pixels of the display panel.

The initializing the first memory upon the power-on may include performing, with the first memory, at least one of a data integrity check operation, a garbage collection operation, or a wear-leveling operation.

The performing the at least one of the data integrity check operation, the garbage collection operation, or the wear-leveling operation may be in response to the PON command.

The method may further include, in response to the PON command, and with the first memory moving data stored in a cache area to a permanent storage area, deleting the data stored in the cache area, storing or updating metadata related to a state of a file system, or performing a defragmentation operation.

The method may further include generating sensing data by sensing characteristics of pixels included in the display panel based on a signal for power-off being provided to the display device, storing the sensing data in the first memory, and providing the PON command to the first memory to organize the data in the first memory.

The method may further include storing, in a second memory of the display device, performance result information indicating whether the first memory has organized the data during a power-off procedure of the display device.

The method may further include reading the performance result information stored in the second memory.

The method may further include anticipating, with the processor, delay in initialization of the first memory based on the performance result information indicating that the first memory has organized the data not being read.

The first memory may include an embedded MultiMedia Card (eMMC), wherein the second memory includes an electrically erasable programmable read-only memory (EEPROM).

A method of driving a display device according to embodiments of the present disclosure is performed for the display device including a display panel, a processor, and a first memory. The method of operating the display device may include initializing the first memory upon power-on, and providing a power-off notification (PON) command to the first memory to organize data in the first memory based on a signal for power-off being provided to the display device.

The organizing of the data in the first memory may include generating sensing data by sensing characteristics of pixels of the display panel, storing the sensing data in the first memory, and providing the PON command to the first memory.

The method may further include storing, in a second memory of the display device, performance result information indicating whether the first memory has performed an operation of organizing the data.

The method may further include reading the performance result information stored in the second memory before initializing the first memory upon the power-on.

The method may further include anticipating, by the processor, delay in initialization of the first memory based on the performance result information indicating that the first memory has completed the operation of organizing the data not being read.

The first memory may include an embedded MultiMedia Card (eMMC), and
wherein the second memory includes an electrically erasable programmable read-only memory (EEPROM).

The method may further include performing, by the first memory, at least one of a data integrity check operation, a garbage collection operation, or a wear-leveling operation to initialize the first memory upon the power-on.

The first memory may perform at least one of the data integrity check operation, the garbage collection operation, or the wear-leveling operation in response to the PON command.

A display device according to embodiments of the present disclosure includes a processor configured to output image data, a display module configured to display an image based on the image data, a first memory configured to store data generated during operation of the display module, and a second memory, wherein the processor is further configured to provide a power-off notification (PON) command to the first memory while the display module displays the image, wherein the first memory is configured to be initialized upon power-on, and is configured to organize internal data in response to the PON, and wherein the second memory is configured to store performance result information indicating whether the first memory organized the internal data.

The first memory may include an embedded MultiMedia Card (eMMC), wherein the second memory includes an electrically erasable programmable read-only memory (EEPROM).

The first memory may be configured to store accumulated data obtained by accumulating the image data, or to store sensing data obtained by sensing characteristics of a transistor in the display module, wherein the processor is configured to provide the PON command to the first memory based on completion of storage of the accumulated data or the sensing data in the first memory.

An electronic device according to embodiments of the present disclosure includes a display device including a processor configured to output image data, a display module configured to display an image based on the image data, a first memory configured to store data generated during operation of the display module, and a second memory, wherein the processor is further configured to provide a power-off notification (PON) command to the first memory while the display module displays the image, wherein the first memory is configured to be initialized upon power-on, and is configured to organize internal data in response to the PON, and wherein the second memory is configured to store performance result information indicating whether the first memory organized the internal data.

The electronic device may include a smartphone, a television, a monitor, a tablet, an electric vehicle, a mobile phone, a tablet personal computer (PC), a mobile communication terminal, an electronic notebook, an electronic book, a portable multimedia player (PMP), a navigation device, an ultra-mobile PC (UMPC), a laptop computer, a billboard, an Internet of Things (IoT) device, a smartwatch, a watch phone, or a head-mounted display (HMD).

Details of other embodiments are included in the detailed description and drawings.

According to a display device and a method of driving the display device, according to embodiments of the present disclosure, by providing a PON command to a first memory periodically or before power-off, the first memory may organize data. Therefore, at the next power-on, an initialization time of the first memory (and a boot time of the display device) may be shortened or stabilized.

In addition, performance result information indicating whether the first memory has performed an operation of organizing the data in response to the PON command may be stored in a second memory, and the performance result information stored in the second memory may be read when the display device is powered on. Therefore, it is possible to prepare for situations where initialization of the first memory (and booting of the display device) may be delayed.

Aspects according to embodiments are not limited to the those described above, and other aspects are included in the present specification.

### BRIEF DESCRIPTION OF THE DRAWINGS

FIG. 1 is a diagram illustrating an electronic device according to embodiments.

FIG. 2 is a diagram illustrating a display device according to one or more embodiments.

FIG. 3 is a diagram illustrating a change in luminance over driving time.

FIG. 4 is a circuit diagram illustrating an example of a pixel included in the display device of FIG. 2.

FIG. 5 is a flowchart illustrating a method of driving a display device according to one or more embodiments.

FIG. 6 is a flowchart illustrating one or more embodiments of an operation of storing accumulated data of FIG. 5.

FIG. 7 is a flowchart illustrating one or more embodiments of an operation of storing sensing data of FIG. 5.

FIG. 8 is a flowchart illustrating a method of driving a display device according to one or more embodiments.

FIG. 9 is a block diagram of an electronic device according to an embodiment.

FIG. 10 shows schematic views of various embodiments of an electronic device.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes of elements in the drawings are arbitrarily illustrated for convenience of description, the disclosure is not limited thereto.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

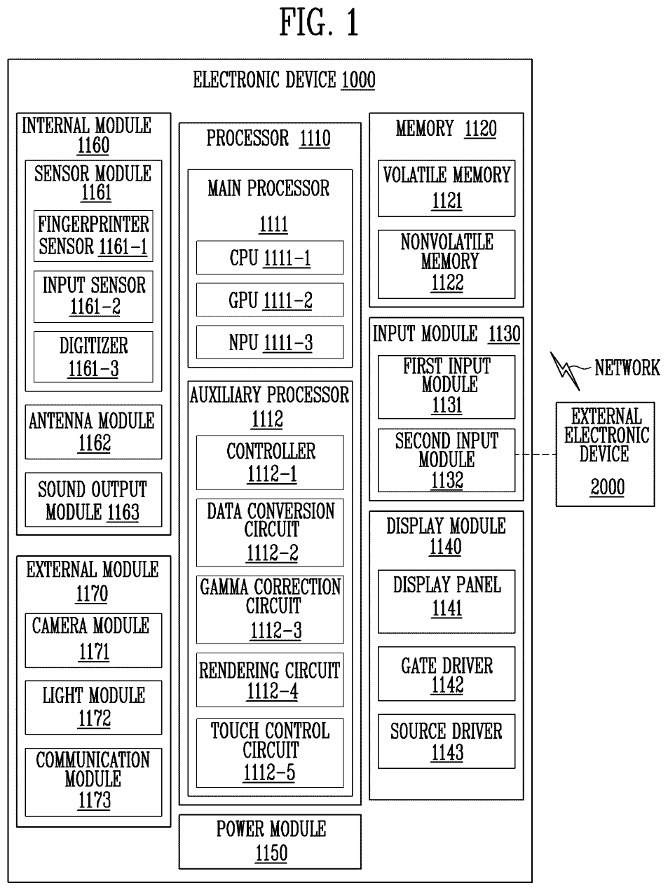

FIG. 1 is a diagram illustrating an electronic device according to embodiments.

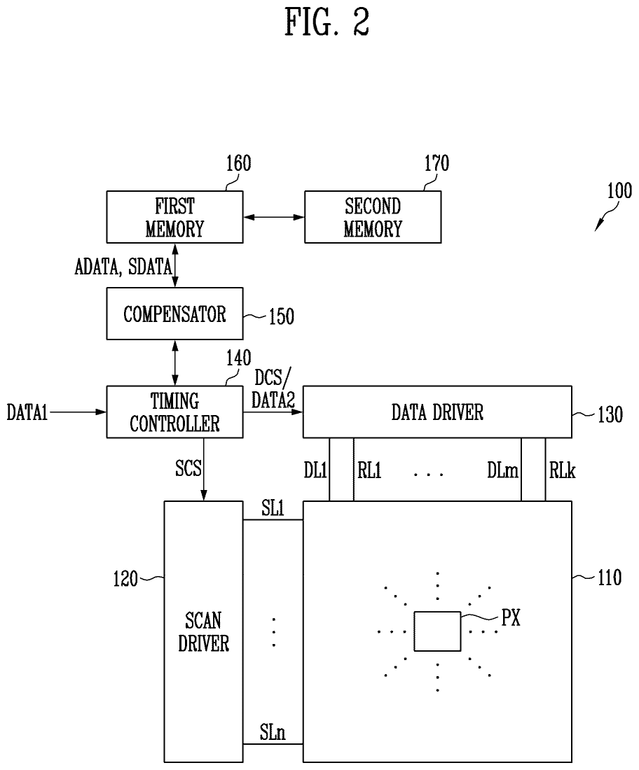

Referring to FIG. 1, an electronic device 1000 outputs a variety of information through a display module 1140. The display module 1140 may correspond to at least a part of a display device 100 shown in FIG. 2. When a processor 1110 executes an application stored in a memory 1120, the display module 1140 provides application information to a user through a display panel 1141.

The processor 1110 acquires an external input through an input module 1130 or a sensor module 1161, and executes an application corresponding to the external input. For example, when the user selects a camera icon displayed on the display panel 1141, the processor 1110 acquires the user's input through an input sensor 1161-2 and activates a camera module 1171. The processor 1110 transmits image data corresponding to a shot image obtained through the camera module 1171 to the display module 1140. The display module 1140 may display an image corresponding to the shot image through the display panel 1141.

As another example, when personal information authentication is performed by the display module 1140, a fingerprint sensor 1161-1 acquires input fingerprint information as input data. The processor 1110 compares the input data acquired through the fingerprint sensor 1161-1 with authentication data stored in the memory 1120 and executes an application according to the comparison result. The display module 1140 may display executed information according to a logic of the application through the display panel 1141.

As another example, when a music streaming icon displayed on the display module 1140 is selected, the processor 1110 acquires the user's input through the input sensor 1161-2, and activates a music streaming application stored in the memory 1120. When a music execution command is input in the music streaming application, the processor 1110 activates a sound output module (e.g., an audio output module, 1163 to provide the user with audio information corresponding to the music execution command.

Above, the operation of the electronic device 1000 has been briefly described. Hereinafter, a configuration of the electronic device 1000 will be described in detail. Some of components of the electronic device 1000 described below may be integrated and provided as one component, and one component may be provided by being separated into two or more components.

The electronic device 1000 may communicate with an external electronic device 2000 through a network (e.g., a short-range wireless communication network or long-range wireless communication network). According to one or more embodiments, the electronic device 1000 may include the processor 1110, the memory 1120, the input module 1130, the display module 1140, a power module 1150, an internal module (e.g., a built-in module) 1160, and an external module 1170. According to one or more embodiments, the electronic device 1000 may have at least one of the above-described components omitted, or one or more other components added. According to one or more embodiments, some components of the above-described components (e.g., the sensor module 1161, an antenna module 1162, or the sound output module 1163) may be integrated into another component (e.g., the display module 1140).

The processor 1110 may execute software to control at least one other component (e.g., a hardware or software component) of the electronic device 1000 connected to the processor 1110 and perform various data processing or operations. According to one or more embodiments, as at least part of the data processing or operations, the processor 1110 may store commands or data received from another component (e.g., the input module 1130, the sensor module 1161, or a communication module 1173) in a volatile memory 1121, may process the commands or data stored in the volatile memory 1121, and may store result data in a non-volatile memory 1122.

The processor 1110 may include a main processor 1111 and an auxiliary processor 1112. The main processor 1111 may include one or more of a central processing unit (CPU) 1111-1 or an application processor (AP). The main processor 1111 may include one or more of a graphic processing unit (GPU) 1111-2, a communication processor (CP), and an image signal processor (ISP). The main processor 1111 may further include a neural processing unit (NPU) 1111-3. The neural processing unit 1111-3 is a processor specialized in processing of an artificial intelligence (AI) model, which may be created through machine learning. The AI model may include a plurality of artificial neural network layers. An artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of them, but is not limited thereto. The AI model may additionally or alternatively include a software structure in addition to a hardware structure. At least two of the processing units and/or processors described above may be implemented as a single integrated configuration (e.g., a single chip) or each may be implemented as an independent configuration (e.g., a plurality of chips).

The auxiliary processor 1112 may include a controller 1112-1. The controller 1112-1 may include an interface conversion circuit and a timing control circuit. The controller 1112-1 receives an image signal from the main processor 1111, converts the data format of the image signal to match the interface specifications with the display module 1140, and outputs image data. The controller 1112-1 may output various control signals necessary for the operation of the display module 1140.

The auxiliary processor 1112 may further include a data conversion circuit 112-2, a gamma correction circuit 1112-3, a rendering circuit 1112-4, and a touch control circuit 1112-5. The data conversion circuit 1112-2 may receive the image data from the controller 1112-1, and may compensate for the image data so that the image is displayed at a desired luminance according to the characteristics of the electronic device 1000 or the user's settings or convert the image data to reduce power consumption or compensate for afterimages. In embodiments, the controller 1112-1 and the data conversion circuit 1112-2 may be configurations corresponding to at least a part of a timing controller 140 shown in FIG. 2.

The gamma correction circuit 1112-3 may convert the image data or a gamma reference voltage, so that the image displayed on the electronic device 1000 has desired gamma characteristics. The rendering circuit 1112-4 may receive the image data from the controller 1112-1 and render the image data in consideration of the pixel placement of the display panel 1141 applied to the electronic device 1000.

The touch control circuit 1112-5 may supply a touch signal to the input sensor 1161-2, and in response to the touch signal, be supplied with a sensing signal from the input sensor 1161-2.

At least one of the data conversion circuit 1112-2, the gamma correction circuit 1112-3, the rendering circuit 1112-4, or the touch control circuit 1112-5 may be integrated into another component (e.g., the main processor 1111 or the controller 1112-1). At least one of the data conversion circuit 1112-2, the gamma correction circuit 1112-3, or the rendering circuit 1112-4 may be integrated into a source driver 1143 described below.

The memory 1120 may store various data used by at least one component of the electronic device 1000 (e.g., the processor 1110 or the sensor module 1161) and input data or output data for instructions related thereto. The memory 1120 may include at least one or more of the volatile memory 1121 and the non-volatile memory 1122.

The input module 1130 may receive commands or data to be used in a component of the electronic device 1000 (e.g., the processor 1110, the sensor module 1161, or the sound output module 1163) from outside the electronic device 1000 (e.g., the user or the external electronic device 2000).

The input module 1130 may include a first input module 1131 into which a command or data is input from the user and a second input module 1132 into which a command or data is input from the external electronic device 2000. The first input module 1131 may include a microphone, a mouse, a keyboard, keys (e.g., buttons), or a pen (e.g., a passive pen or an active pen). The second input module 1132 may support a specified protocol which may be connected wired or wirelessly to the external electronic device 2000. According to one or more embodiments, the second input module 1132 may include a high definition multimedia interface (HDMI), a universal serial bus (USB) interface, an SD card interface, or an audio interface. The second input module 1132 may include a connector (e.g., an HDMI connector, a USB connector, an SD card connector, or an audio connector (e.g., a headphone connector)) which may physically connect it to the external electronic device 2000.

The display module 1140 provides information visually to the user. The display module 1140 may include the display panel 1141, a gate driver 1142, and the source driver 1143. The gate driver 1142 may be a configuration corresponding to at least a part of a scan driver 120 shown in FIG. 2. The source driver 1143 may be a configuration corresponding to at least a part of a data driver 130 shown in FIG. 2. The display module 1140 may further include a window, chassis, and bracket to protect the display panel 1141.

The display panel 1141 (or a display) may include a liquid crystal display panel, an organic light-emitting display panel, or an inorganic light-emitting display panel, and the type of display panel 1141 is not particularly limited. The display panel 1141 may be of a rigid type, or a rollable or foldable flexible type. The display module 1140 may further include supporters, brackets, or heat dissipation elements supporting the display panel 1141.

The gate driver 1142 may be mounted on the display panel 1141 as a driving chip. Further, the gate driver 1142 may be integrated into the display panel 1141. For example, the gate driver 1142 may include an amorphous silicon TFT gate driver circuit (ASG), a low temperature polycrystalline silicon (LTPS) TFT gate driver circuit, or an oxide semiconductor TFT gate driver circuit (OSG) embedded in the display panel 1141. The gate driver 1142 receives a control signal from the controller 1112-1 and, in response to the control signal, outputs scanning signals to the display panel 1141.

The source driver 1143 receives a control signal from the controller 1112-1 and, in response to the control signal, converts the image data into analog voltage (e.g., a data signal) to output the data signal to the display panel 1141.

The source driver 1143 may be integrated into another component (e.g., the controller 1112-1). Functions of the interface conversion circuit and the timing control circuit of the controller 1112-1 may also be integrated into the source driver 1143.

The display module 1140 may further include a voltage generation circuit. The voltage generation circuit may output various voltages required for the operation of the display panel 1141. In embodiments, the display panel 1141 may include a plurality of pixel columns, each of which includes a plurality of pixels.

In embodiments, the source driver 1143 may convert data corresponding to red (R), green (G), and blue (B) included in the image data received from the processor 1110 into a red data signal (or data voltage), a green data signal, and a blue data signal, and may provide the signals to the plurality of pixel columns included in the display panel 1141 for a single horizontal period.

The power module 1150 supplies power to the components of the electronic device 1000. The power module 1150 may include a battery to charge a power supply voltage. The battery may include a non-rechargeable primary battery, a rechargeable secondary battery, or a fuel cell. The power module 1150 may include a power management integrated circuit (PMIC). The PMIC supplies optimized power for each of the above-mentioned modules and modules which will be described below. The power module 1150 may include a wireless power-transmitting-and-receiving member electrically connected to the battery. The wireless power-transmitting-and-receiving member may include a plurality of coil-shaped antenna radiators.

The electronic device 1000 may further include the internal module 1160 and the external module 1170. The internal module 1160 may include the sensor module 1161, the antenna module 1162, and the sound output module 1163. The external module 1170 may include the camera module 1171, a light module 1172, and the communication module 1173.

The sensor module 1161 may detect an input by the user's body or an input by the pen of the first input module 1131, and may generate an electrical signal or data value corresponding to the input. The sensor module 1161 may include at least one or more of the fingerprint sensor 1161-1, the input sensor 1161-2, and a digitizer 1161-3.

The fingerprint sensor 1161-1 may generate a data value corresponding to the user's fingerprint. The fingerprint sensor 1161-1 may include either an optical or capacitive fingerprint sensor.

The input sensor 1161-2 may generate a data value corresponding to coordinate information of the input by the user's body or the input by the pen. The input sensor 1161-2 generates an amount of changes in capacitance by the input as a data value. The input sensor 1161-2 may detect an input by the passive pen, or may transmit and receive data with the active pen.

The input sensor 1161-2 may also measure a biosignal, such as blood pressure, moisture, or body fat. For example, when the user touches a part of his or her body to a sensor layer or a sensing panel and does not move for a period of time (e.g., predetermined period of time), the input sensor 1161-2 may detect the biosignal based on a change in the electric field caused by the part of his or her body, and may output information desired by the user to the display module 1140.

The digitizer 1161-3 may generate a data value corresponding to the coordinate information of the input by the pen. The digitizer 1161-3 generates an amount of electromagnetic change by the input as a data value. The digitizer 1161-3 may detect the input by the passive pen, or may transmit and receive data with the active pen.

At least one of the fingerprint sensor 1161-1, the input sensor 1161-2, or the digitizer 1161-3 may be implemented as a sensor layer formed on the display panel 1141 by means of a continuous process. At least one of the fingerprint sensor 1161-1, the input sensor 1161-2, or the digitizer 1161-3 may be placed on the upper side of the display panel 1141, and any one of the fingerprint sensor 1161-1, the input sensor 1161-2, or the digitizer 1161-3 may be placed on the lower side of the display panel 1141.

At least two of the fingerprint sensor 1161-1, the input sensor 1161-2, and/or the digitizer 1161-3 may be configured to be integrated into a single sensing panel through the same process. When integrated into the single sensing panel, the sensing panel may be placed between the display panel 1141 and a window placed on the upper side of the display panel 1141. According to one or more embodiments, the sensing panel may be placed on the window, and the position of the sensing panel is not particularly limited.

At least one of the fingerprint sensor 1161-1, the input sensor 1161-2, or the digitizer 1161-3 may be built in the display panel 1141. In other words, at least one of the fingerprint sensor 1161-1, the input sensor 1161-2, or the digitizer 1161-3 may be formed concurrently or substantially simultaneously through a process of forming elements included in the display panel 1141 (e.g., a light-emitting element, a transistor, and the like).

In addition, the sensor module 1161 may generate an electrical signal or a data value corresponding to an internal or external state of the electronic device 1000. The sensor module 1161 may further include, for example, a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or a light sensor.

The antenna module 1162 may include one or more antennas for transmitting or receiving signals or power to or from the outside. In one or more embodiments, the communication module 1173 may transmit a signal to an external electronic device through an antenna appropriate to a communication method, or may receive a signal from the external electronic device. An antenna pattern of the antenna module 1162 may be integrated into one configuration of the display module 1140 (e.g., the display panel 1141) or the input sensor 1161-2.

The sound output module 1163 is a device for outputting an audio signal to the outside of the electronic device 1000, and may include, for example, a speaker used for general purposes, such as multimedia playback or recording playback and a receiver used exclusively for telephone reception. According to one or more embodiments, the receiver may be formed integrally with or separately from the speaker. An audio output pattern of the sound output module 1163 may be integrated into the display module 1140.

The camera module 1171 may shoot still images and videos. According to one or more embodiments, the camera module 1171 may include one or more lenses, an image sensor, or an image signal processor. The camera module 1171 may further include an infrared camera which is capable of measuring the presence or absence of the user, the user's position, the user's line of sight, and the like.

The light module 1172 may provide light. The light module 1172 may include a light-emitting diode or a xenon lamp. The light module 1172 may operate in conjunction with the camera module 1171 or may operate independently.

The communication module 1173 may support establishment of a wired or wireless communication channel between the electronic device 1000 and the external electronic device 2000, and may support performance of communication over the established communication channel. The communication module 1173 may include or any one or all of a wireless communication module, such as a cellular communication module, a short-range wireless communication module, or a global navigation satellite system (GNSS) communication module, and a wired communication module, such as a local area network (LAN) communication module, or a power line communication module. The communication module 1173 may communicate with the external electronic device 2000 via a short-range communication network, such as Bluetooth®, WiFi® direct (Wi-Fi@ being a registered trademark of the non-profit Wi-Fi Alliance, and Bluetooth® being a registered trademark of Bluetooth Sig, Inc., Kirkland, WA), or IrDA (infrared data association), or a long-range communication network, such as a cellular network, the Internet, or a computer network (e.g., a LAN or WAN). The various types of communication modules 1173 described above may be implemented as one chip or as separate chips.

The input module 1130, the sensor module 1161, the camera module 1171, and the like, may be used to control the operation of the display module 1140 in conjunction with the processor 1110.

The processor 1110 outputs commands or data to the display module 1140, the sound output module 1163, the camera module 1171, or the light module 1172 based on the input data received from the input module 1130. For example, the processor 1110 may generate image data in response to input data received through the mouse or the active pen, and may output the image data to the display module 1140, or may generate command data in response to the input data, and may output the command data to the camera module 1171 or the light module 1172. When no input data is received from the input module 1130, the processor 1110 may reduce power consumption of the electronic device 1000 by switching an operation mode of the electronic device 1000 to a low power mode or a sleep mode.

The processor 1110 outputs commands or data to the display module 1140, the sound output module 1163, the camera module 1171, or the light module 1172 based on the sensing data received from the sensor module 1161. For example, the processor 1110 may compare authentication data authorized by the fingerprint sensor 1161-1 with authentication data stored in the memory 1120, and then may execute an application based on a result of the comparison. The processor 1110 may execute a command based on the sensing data detected by the input sensor 1161-2 or the digitizer 1161-3, or may output the corresponding image data to the display module 1140. If the sensor module 1161 includes the temperature sensor, the processor 1110 may receive temperature data for measured temperature from the sensor module 1161 and, based on the temperature data, further perform luminance correction for the image data.

The processor 1110 may receive measurement data regarding the presence or absence of the user, the user's position, the user's line of sight, and the like, from the camera module 1171. The processor 1110 may further perform luminance correction on the image data based on the measurement data. For example, the processor 1110, which has determined the presence or absence of the user through input from the camera module 1171, may output image data whose luminance has been corrected to the display module 1140 through the data conversion circuit 1112-2 or the gamma correction circuit 1112-3.

Some of the components may be connected to each other via a communication method between peripherals (e.g., a bus, general purpose input/output (GPIO), serial peripheral interface (SPI), mobile industry processor interface (MIPI), or ultra-path interconnect (UPI) link) to exchange signals (e.g., commands or data) with each other. The processor 1110 may communicate with the display module 1140 through a mutually agreed upon interface, and for example, may use any one of the above-described communication methods, but not limited to the above-described communication methods.

The electronic device 1000 may be a device of various types. The electronic device 1000 may, for example, include at least one of a portable communication device (e.g., a smartphone), a computer device, a portable multimedia device, a portable medical device, a camera, a wearable device, or a consumer electronics device. The electronic device 1000 of other embodiments is not limited to the devices described above.

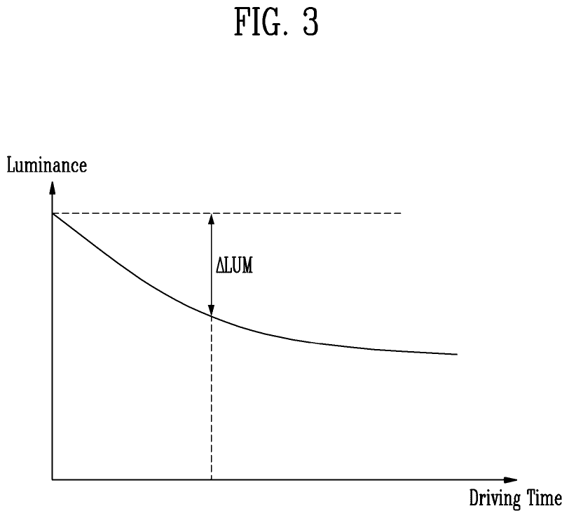

FIG. 2 is a diagram illustrating a display device according to one or more embodiments. FIG. 3 is a diagram illustrating a change in luminance over driving time.

Referring to FIG. 2, the display device 100 may include a display 110 (or a display panel), the scan driver 120, the data driver 130, and the timing controller 140. Further, the display device 100 (or the electronic device 1000 of FIG. 1) may further include a compensator 150, a first memory 160 (or a first memory device, a first storage), and a second memory 170 (or a second memory device, a second storage).

The display 110 may include scan lines (SL1 to SLn, where n is a positive integer), data lines (DL1 to DLm, where m is a positive integer), and a pixel (PX). The pixel (PX) may be provided in an area (e.g., a pixel area) defined by the scan lines (SL1 to SLn) and the data lines (DL1 to DLm). The pixel (PX) may be connected to one of the scan lines (SL1 to SLn) and one of the data lines (DL1 to DLm).

The pixel (PX) includes a light-emitting element and a pixel circuit, and the pixel circuit may include at least one transistor, the pixel circuit may transmit a current (or a current amount) corresponding to a data signal provided through the data line to the light-emitting element in response to a scan signal provided through the scan line, and the light-emitting element may emit light with a luminance corresponding to the current (e.g., the luminance corresponding to the data signal).

Further, the display 110 may further include readout lines (RL1 to RLk). Here, k is a positive integer, which may be less than or equal to m. In this case, the pixel (PX) may be connected to one of the readout lines (RL1 to RLk).

The scan driver 120 may generate a scan signal based on a scan control signal (SCS), and may provide the scan signal sequentially to the scan lines (SL1 to SLn). Here, the scan control signal (SCS) may include a start signal and clock signals, and may be provided from the timing controller 140. For example, the scan driver 120 may include a shift register, which uses clock signals to sequentially generate and output a pulse-shaped scan signal corresponding to a pulse-shaped start signal.

The data driver 130 may generate data signals based on second data (DATA2) (or image data, frame data) and data control signal (DCS) provided from the timing controller 140, and may provide the data signals to the display 110 (or the pixel PX). Here, the data control signal (DCS) is a signal which controls the operation of the data driver 130 and may include a load signal (or a data enable signal), which instructs output of a valid data signal.

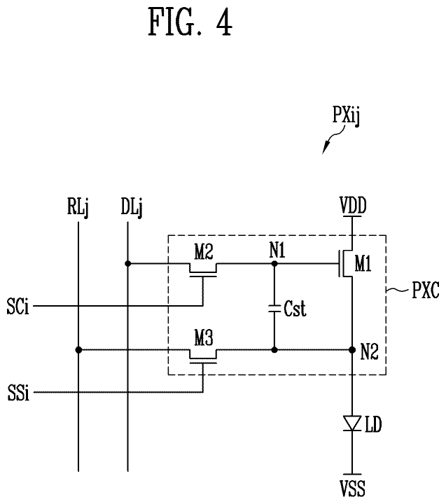

Further, the data driver 130 may sense characteristics of the pixel (PX) through the readout lines (RL1 to RLk). For example, the data driver 130 may sense a current or voltage received through one of the readout lines (RL1 to RLk) as a characteristic of the pixel (PX). For example, the sensed characteristics may be a mobility of a driving transistor in the pixel (PX), a threshold voltage, and/or a degree of deterioration of the light-emitting element. The data driver 130 may change or compensate for a driving voltage of the pixel (PX) (e.g., a voltage applied to the second node (N2) through a third transistor (M3) of FIG. 4) based on the sensed characteristics. In this case, even if the mobility of the driving transistor or the threshold voltage changes, the pixel (PX) may emit light at a desired luminance. The sensed characteristics may be stored in the first memory 160 as sensing data (SDATA). For example, a sensing operation of the data driver 130 may be performed immediately prior to power-off of the display device 100, and immediately after the sensing operation, the sensing data (SDATA) may be stored in the first memory 160.

The timing controller 140 may receive first data (DATA1) (or input image data) and a control signal from the outside (e.g., the processor 1110 in FIG. 1, or the main processor 1111), may generate the scan control signal (SCS) and the data control signal (DCS) based on the control signal, and may convert the first data (DATA1) to generate the second data (DATA2).

The compensator 150 may generate accumulated data (ADATA) by accumulating the first data (DATA1) or the second data (DATA2), and may compensate for the second data (DATA2) based on the accumulated data (ADATA). For example, the compensator 150 may generate the accumulated data (ADATA) by accumulating a gradation value for the pixel (PX) every frame, and may compensate for the gradation value for the pixel (PX) based on the accumulated data (ADATA). In this case, even if the light-emitting element deteriorates, the pixel (PX) may emit light at the desired luminance. The accumulated data (ADATA) indicates a degree of usage, a degree of deterioration, or a degree of stress of the pixel (PX), or lifespan of the pixel (PX) accordingly, and thus, the accumulated data (ADATA) may be called stress data, life data, or the like.

Referring to FIG. 3, as a driving time of the pixel (PX) increases, the luminance of the pixel (PX) (or, the luminance of the display 110) for the same gradation value may decrease along the luminance curve shown in FIG. 3. Here, the driving time may be a value which reflects the gradation value on a time of driving. For example, the driving time may be a value obtained by multiplying the gradation value and the time and accumulating them. Because the time has no weighting, the driving time may correspond to the accumulated data (ADATA), which accumulates the gradation values. The compensator 150 may acquire a reduced luminance compared to a target (e.g., a luminance difference (ΔLUM)), based on the accumulated data (ADATA), and may compensate for the gradation value for the pixel (PX) in response to the luminance difference (ΔLUM).

The compensator 150 may load the accumulated data (ADATA) from the first memory 160, may update the accumulated data (ADATA) based on the gradation values included in the first data (DATA1) or the second data (DATA2), and may periodically provide or store the updated accumulated data (ADATA) in the first memory 160. For example, the compensator 150 may update the accumulated data (ADATA) by accumulating the first data (DATA1) or the second data (DATA2) in the accumulated data (ADATA).

The compensator 150 may be included in the processor 1110 of FIG. 1. For example, the compensator 150 may be included in the main processor 1111 of FIG. 1, but is not limited thereto. For example, the compensator 150 may be included in the auxiliary processor 1112 of FIG. 1 or the timing controller 140 of FIG. 2.

The first memory 160 may store accumulated data (ADATA) and the sensing data (SDATA). For the accuracy of the accumulated data (ADATA) which is periodically generated or updated in the compensator 150, the accumulated data (ADATA) may be periodically stored in the first memory 160. In addition to data generated during operation of the display device 100, the first memory 160 may further store large-capacity data required for the operation of the display device 100, such as an operating system, applications, and user data.

The first memory 160 may be connected to the compensator 150, but is not limited thereto. For example, the first memory 160 may be connected to the timing controller 140.

In one or more embodiments, the first memory 160 may be implemented as a non-volatile memory device. For example, the first memory 160 may be an embedded multimedia card (eMMC). The first memory 160 may provide fast read/write speeds and improve the performance of the display device 100. The first memory 160 may be included in the memory 1120 or the non-volatile memory 1122 of FIG. 1.

In one or more embodiments, the first memory 160 may be initialized or perform an initialization operation upon power-on of the display device 100. The first memory 160 may be initialized to ensure that the display device 100 always starts in the same state (e.g., to ensure system stability), and also to ensure that the display device 100 boots properly (e.g., to ensure data integrity). For example, the first memory 160 may perform at least one of a data integrity check operation, a garbage collection operation, or a wear-leveling operation. The data integrity check operation may check for data corruption and repair it. The garbage collection operation may clean up unnecessary data blocks. The wear-leveling operation may check and adjust a wear-leveling state to extend the life of the first memory 160. For reference, the more the first memory 160 is used or the higher the usage, the more time it may take to perform the data integrity check operation, the garbage collection operation, and the wear-leveling operation. In other words, the more the first memory 160 is used or the higher the usage, the more the initialization time of the first memory 160 may increase. For example, the initialization time may increase to more than one second.

In one or more embodiments, the first memory 160 may organize the data in the first memory 160 in response to a power-off notification (PON) command. The PON command may be a signal used to notify the display device 100 (or the electronic device of FIG. 1) before power is turned off, and may be provided from, for example, the processor 1110 of FIG. 1 (e.g., an AP), and may be provided to a power supply device, such as the power module 1150 of FIG. 1. If the PON command is provided to the first memory 160, the first memory 160 may organize the data within the first memory 160 so that it can complete the current task in progress and be safely terminated. For example, in response to the PON command, the first memory 160 may perform at least one of the data integrity check operation, the garbage collection operation, or the wear-leveling operation. For example, in response to the PON command, the first memory 160 may move or delete data stored in a cache area to a permanent storage area, store or update metadata related to a state of a file system, or perform a defragmentation operation. The metadata may include information, such as the location, size, and modification time of the file.

In one or more embodiments, during the operation of the display device 100 (e.g., while displaying the image), the processor 1110 of FIG. 1 may periodically provide the PON command to the first memory 160, and the first memory 160 may periodically organize data in response to the PON command. For example, the accumulated data (ADATA) may be periodically stored in the first memory 160, and at each point in time when the storage of the accumulated data (ADATA) is completed, the processor 1110 of FIG. 1 may provide the PON command to the first memory 160. If the data in the first memory 160 is periodically organized in response to the PON command, the initialization time of the first memory 160 (and the boot time of the display device 100) may be shortened at the next power-on of the display device 100 even if the first memory 160 is heavily used, or has a high usage volume, and the deviation of the initialization time of the first memory 160 may be reduced and stabilized.

In one or more embodiments, when a signal for power-off is provided from the outside (for example, when the signal is provided through an input to a physical power button of the display device 100 or via a remote control), the processor 1110 of FIG. 1 may provide the PON command to the first memory 160, and the first memory 160 may organize data in response to the PON command. For example, when the signal for power-off is provided from the outside, the data driver 130 performs the sensing operation, and the sensing data (SDATA) resulting from the sensing operation is stored in the first memory 160, and at the time the storage of the sensing data (SDATA) is completed, the processor 1110 of FIG. 1 may provide the PON command to the first memory 160. For reference, because the first memory 160 is initialized upon power-on of the display device 100, when the display device 100 is powered off, the processor 1110 of FIG. 1 may not separately control the first memory 160, but in this case, the initialization time of the first memory 160 changes randomly depending on the degree of usage of the first memory 160, and a stable boot time of the display device 100 may not be secured. Thus, in embodiments, the initialization time of the first memory 160 (and the boot time of the display device 100) may be shortened or stabilized by providing the PON command to the first memory 160 prior to power-off of the display device 100 to organize the data in the first memory 160.

The second memory 170 may be implemented as a non-volatile memory device, such as an Erasable Programmable Read-Only Memory (EPROM), an Electrically Erasable Programmable Read-Only Memory (EEPROM), a flash memory, a Phase Change Random Access Memory (PRAM), a Resistance Random Access Memory (RRAM), a Nano Floating Gate Memory (NFGM), a Polymer Random Access Memory (PoRAM), a Magnetic Random Access Memory (MRAM), and/or a Ferroelectric Random Access Memory (FRAM). For example, the second memory 170 may be implemented as an EEPROM. The second memory 170 may store a small amount of important data, such as setting values of the display device 100, firmware update information, and user settings, but is not limited thereto. The second memory 170 may be included in the memory 1120 or the non-volatile memory 1122 of FIG. 1. The second memory 170 may be connected to the first memory 160, but is not limited thereto. For example, the second memory 170 may be connected to the compensator 150 or the timing controller 140.

In one or more embodiments, performance result information (e.g., information on whether PON has been performed, or PON performance information) indicating whether the first memory 160 has performed an operation to organize data in response to the PON command may be stored in the second memory 170. For example, if the first memory 160 performs an operation to organize the data in response to the PON command, the performance result information with a value of “1” may be stored in the second memory 170. When the display device 100 is powered on, the processor 1110 of FIG. 1 may read the performance result information stored in the second memory 170. For example, when reading the performance result information, the performance result information stored in the second memory 170 may be reset to have a value of “0”. The result information with a value of “0” may indicate that the first memory 160 has not performed an operation to organize the data in response to the PON command. For example, if an external power cord or a battery of the display device 100 is removed and the display device 100 is abnormally powered off, the first memory 160 may not perform the data organization operation, and the initialization time of the first memory 160 (and the boot time of the display device 100) may increase at the next power-on. The processor 1110 may predict the initialization time (and the boot time of the display device 100) by reading the performance result information stored in the second memory 170. For example, when reading performance result information having a value of “0” (in other words, when failing to read the performance result information having a value of “1”), the processor 1110 may anticipate that initialization of the first memory 160 (and booting of the display device 100) may be delayed, and may prepare for the delay.

As described above, the PON command may be provided to the first memory 160 periodically or before power-off so that the first memory 160 can organize data periodically or before power-off. Thus, at the next power-on, the initialization time (and the boot time of the display device 100) of the first memory 160 may be shortened or stabilized.

Further, the performance result information indicating whether the first memory 160 has performed the operation of organizing the data in response to the PON command may be stored in the second memory 170, and the performance result information stored in the second memory 170 may be read when the display device 100 is powered on. Therefore, it is possible to anticipate that the initialization of the first memory 160 (and the booting of the display device 100) may be delayed, and to prepare for the delay.

FIG. 4 is a circuit diagram illustrating an example of the pixel included in the display device of FIG. 2. FIG. 4 shows an ij-th pixel (PXij) located in the i-th horizontal line (or pixel row) and the j-th vertical line (or pixel column).

Referring to FIG. 4, the PXij may include a pixel circuit (PXC) and a light-emitting element (LD). The pixel circuit (PXC) may include transistors (M1 to M3) and a storage capacitor (Cst). The transistors (M1, M2, M3) may be, but are not limited to, n-type transistors.

The first transistor (M1) (or the driving transistor) may have a gate electrode connected to a first node (N1), one electrode (or a first electrode) connected to a first power line (VDD) (or a first power supply), and the other electrode (or a second electrode) connected to a second node (N2).

The second transistor (M2) may have a gate electrode connected to an i-th scan line (SCi), one electrode connected to a j-th data line (DLj), and the other electrode connected to the first node (N1). The i-th scan line (SCi) and an i-th sensing scan line (SSi) may be included in the scan lines (SL1 to SLn) of FIG. 2.

The third transistor (M3) may have a gate electrode connected to the i-th sensing scan line (SSi), one electrode connected to the i-th readout line (RLi), and the other electrode connected to the second node (N2).

The storage capacitor (Cst) may have one electrode connected to the first node (N1), and the other electrode connected to the second node (N2).

The light-emitting element (LD) may have an anode connected to the second node (N2), and a cathode connected to a second power line (VSS) (or a second power supply). The light-emitting element (LD) may be, but is not limited to, an organic light emitting diode. For example, the light-emitting element (LD) may be an inorganic light emitting diode.

The characteristics of the pixel (PXij) may be sensed by the data driver 130 of FIG. 2. For example, if a test voltage is applied to the j-th data line (DLj) and a scan signal having a gate-on voltage level is provided to the i-th scan line (SCi), the test voltage is transmitted to the first node (N1), and the first transistor (M1) may transmit a current corresponding to the test voltage to the second node (N2). When the scan signal having a gate-on voltage level is provided to the i-th sensing scan line (SSi), the second node (N2) and the i-th readout line (RLi) are connected, and a current (e.g., a current flowing to the first transistor (M1) according to the test voltage) or a voltage (e.g., a voltage reflecting a threshold voltage of the first transistor (M1)) may be provided to the i-th readout line (RLi). Based on the current or the voltage, the characteristics of the pixel (PXij) (e.g., the mobility and the threshold voltage of the first transistor (M1)) may be derived.

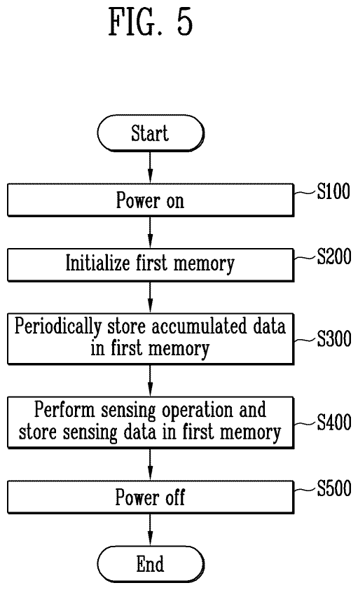

FIG. 5 is a flowchart illustrating a method of driving a display device according to one or more embodiments. The method of FIG. 5 may be performed by the display device 100 of FIG. 2 or the electronic device 1000 of FIG. 1.

Referring to FIG. 1, FIG. 2, and FIG. 5, the display device 100 may be powered on (S100). When an external power supply is connected or an external power is supplied to the display device 100, the display device 100 may be powered on (S100).

Then, the display device 100 may be booted. During a booting process of the display device 100, the first memory 160 may be initialized (S200). As described in FIG. 2, the first memory 160 may perform at least one of the data integrity check operation, the garbage collection operation, or the wear-leveling operation.

When booting is complete and the display device 100 is operating (e.g., while displaying an image), data is generated, and the data may be stored in the first memory 160.

For example, while the display device 100 is operating (for example, while displaying the image), the compensator 150 may generate the accumulated data (ADATA, see FIG. 2), and the accumulated data (ADATA) may be periodically stored in the first memory 160 (S300).

For example, when a signal for power-off is provided to the display device 100 from the outside, the data driver 130 may perform a sensing operation to sense the characteristics of the pixel (PX), and the sensing data (SDATA, see FIG. 2) according to the sensing operation may be stored in the first memory 160 (S400). After the sensing data (SDATA) is stored in the first memory 160, the display device 100 may be powered off (S500).

Because the first memory 160 is initialized when the display device 100 is powered on, the processor 1110 of FIG. 1 may not separately control the first memory 160 when the display device 100 is powered off, but in this case, the initialization time of the first memory 160 may be randomly changed according to the degree to which the first memory 160 is used while the display device 100 operates, and a stable boot time of the display device 100 may not be secured. Thus, in embodiments, by providing the PON command to the first memory 160 at least once before powering off the display device 100 to organize data in the first memory 160, the initialization time of the first memory 160 (and the boot time of the display device 100) may be shortened or stabilized.

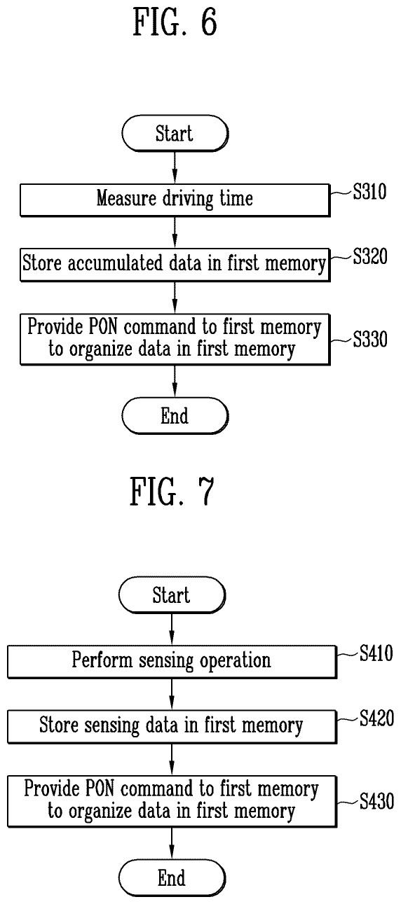

FIG. 6 is a flowchart illustrating one or more embodiments of the operation of storing the accumulated data of FIG. 5.

Referring to FIGS. 5 and 6, when booting is complete and the display device 100 is operating (e.g., while displaying the image), the driving time may be measured (S310). For example, the display device 100 may measure the driving time by counting the number of frames (or pulses of the signal periodically provided while the display device 100 operates).

When the measured driving time has a corresponding value, the accumulated data (ADATA) may be stored in the first memory 160 (S320).

When storage of the accumulated data (ADATA) in the first memory 160 is completed, the processor 1110 of FIG. 1 may provide the PON command to the first memory 160, and the first memory 160 may organize the data in response to the PON command (S330). When the first memory 160 operates in response to the PON command, the first memory 160 may be changed to an inoperable state. According to embodiments, if the first memory 160 completes the operation in accordance with the PON command, the first memory 160 may be changed back to the operable state.

During operation of the display device 100, measurement of the driving time (S310), storage of the accumulated data (ADATA) (S320), and data organization (S330) may be repeated periodically.

Therefore, the accumulated data (ADATA) is stored in the first memory 160 at corresponding times, and whenever the storage of the accumulated data (ADATA) in the first memory 160 is completed, the data in the first memory 160 may be organized in response to the PON command.

FIG. 7 is a flowchart illustrating one or more embodiments of the operation of storing the sensing data of FIG. 5.

Referring to FIGS. 5 and 7, when a signal for power-off is provided to the display device 100 from the outside, the display device 100 may perform the sensing operation for sensing the characteristics of the pixel (PX) (S410).

When the sensing operation is completed, the sensing data (SDATA) resulting from the sensing operation may be stored in the first memory 160 (S420).

When the storage of the sensing data (SDATA) is completed in the first memory 160, the processor 1110 of FIG. 1 may provide the PON command to the first memory 160, and the first memory 160 may organize the data in response to the PON command (S430).

In this way, during the power-off procedure, the sensing data (SDATA) is stored in the first memory 160, and when the storage of the sensing data (SDATA) in the first memory 160 is completed, the data of the first memory 160 may be organized in response to the PON command.

As described with reference to FIGS. 5 to 7, at the time when the storage of the accumulated data (ADATA) is completed and/or at the time when the storage of the sensing data (SDATA) is completed in the first memory 160, the PON command may be provided to the first memory 160, and the data of the first memory 160 may be organized in response to the PON command.

On the other hand, in FIGS. 5 to 7, the accumulated data (ADATA) is periodically stored in the first memory 160, but is not limited thereto. For example, the accumulated data (ADATA) may be stored in the first memory 160 only when the power-off procedure is in progress, and the PON command may be provided to the first memory 160 when the storage of the accumulated data (ADATA) is completed.

Further, in FIGS. 5 to 7, the sensing data (SDATA) is described as being stored in the first memory 160 during the power-off procedure, but is not limited thereto. For example, the sensing data (SDATA) is periodically stored in the first memory 160 during the operation of the display device 100, and the PON command may be provided to the first memory 160 at each point in time when the storage of the sensing data (SDATA) is completed.

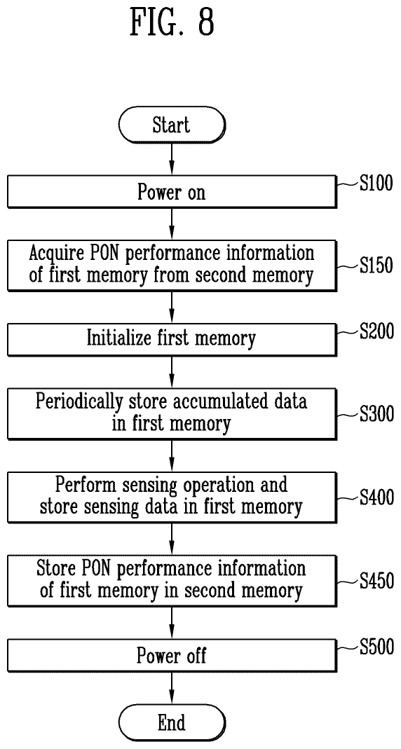

FIG. 8 is a flowchart illustrating a method of driving a display device according to one or more embodiments. The method of FIG. 8 may be performed in the display device 100 of FIG. 2 or the electronic device 1000 of FIG. 1.

Referring to FIGS. 1, 2, 5 to 8, the method of FIG. 8 may further include an operation of acquiring or reading PON performance information (or performance result information) of the first memory 160 from the second memory 170 (S150), and an operation of storing the PON performance information of the first memory 160 in the second memory 170 (S450).

The display device 100 may be powered-on (S100).

Afterwards, the display device 100 may be booted. During the booting process of the display device 100, before initializing the first memory 160 or while initializing the first memory 160, the processor 1110 of FIG. 1 may obtain the PON performance information stored in the second memory 170 from the second memory 170. As described with reference to FIG. 2, the PON performance information (or performance result information) may indicate whether the first memory 160 has performed the operation of organizing data in response to the PON command. For example, if it is determined from the PON performance information that the first memory 160 has performed the operation of organizing the data, the processor 1110 may drive the display device 100 without any additional operation. For example, if it is determined from the PON performance information that the first memory 160 has not performed the operation of organizing data, the processor 1110 may anticipate that the initialization of the first memory 160 (and booting of the display device 100) may be delayed, and may prepare for the delay. For example, the processor 1110 may drive the display device 100 after a sufficient amount of time has passed.

During the booting process of the display device 100, the first memory 160 may be initialized (S200).

When booting is complete and the display device 100 is operating (e.g., while displaying an image), data may be generated, and the data may be stored in the first memory 160.

For example, while the display device 100 is operating (for example, while displaying the image), the compensator 150 may generate the accumulated data (ADATA, see FIG. 2), and the accumulated data (ADATA) may be periodically stored in the first memory 160 (S300).

In one or more embodiments, while the display device 100 is operating, for example, after the display device 100 has booted, and before the power-off procedure is performed, the processor 1110 of FIG. 1 may not provide the PON command to the first memory 160. For reference, by providing the PON command to the first memory 160 while the display device 100 is operating, an increase in the initialization time (and the boot time) of the first memory 160 due to an abnormal power-off may be prevented. However, in the one or more embodiments corresponding to FIG. 8, because the delay in the initialization time (and the boot time) of the first memory 160 may be predicted and prepared for based on the PON performance information, it may not be necessary to provide the PON command to the first memory 160 during the operation of the display device 100. However, the present disclosure is not limited thereto, and PON command may be provided to the first memory 160 even while the display device 100 is operating.

For example, when a signal for power-off is provided to the display device 100 from the outside, the data driver 130 may perform the sensing operation for sensing the characteristics of the pixel (PX), and the sensing data (SDATA, see FIG. 2) according to the sensing operation may be stored in the first memory 160 (S400).

As described with reference to FIG. 7, when the storage of the sensing data (SDATA) is completed in the first memory 160, the processor 1110 of FIG. 1 may provide the PON command to the first memory 160, and the first memory 160 may organize the data in response to the PON command.

Thereafter, the PON performance information of the first memory 160 may be stored in the second memory 170 (S450). If the display device 100 is powered off normally, the first memory 160 will normally perform the operation of organizing the data in response to the PON command, and the PON performance information indicating that the operation has been performed may be stored or updated. On the other hand, if the display device 100 is abnormally powered off, the first memory 160 might not sufficiently perform the operation to organize the data, and the PON performance information indicating that the operation has not been performed may be stored or maintained.

After the sensing data (SDATA) is stored in the first memory 160, the display device 100 may be powered off (S500).

As described above, the PON performance information (or the performance result information) indicating whether the first memory 160 has performed the operation to organize the data in response to the PON command is stored in the second memory 170, and the performance result information stored in the second memory 170 may be read when the display device 100 is powered on. Therefore, it is possible to anticipate that the initialization of the first memory 160 (and the booting of the display device 100) may be delayed, and to prepare for the delay.

A display device according to an embodiment is applicable to various types of electronic devices. In an embodiment, an electronic device includes the above-described display device and may further include other modules or devices having additional functions in addition to the display device.

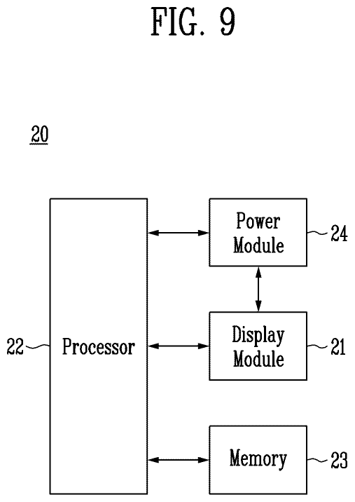

FIG. 9 is a block diagram of an electronic device according to an embodiment. Referring to FIG. 9, the electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller.

The memory 13 may store data and/or information used to operate the processor 12 or the display module 11. When the processor 12 executes an application stored in the memory 13, image data signals and/or input control signals may be transferred to the display module 11. The display module 11 may process the provided signals and output image information on a display screen.

The power module 14 may include a power supply module, such as a power adapter or a battery device, and a power conversion module. The power conversion module converts power supplied by the power supply module and generates power to operate the electronic device 10.

At least one of the above-described components of the electronic device 10 may be included in the display device according to embodiments as described above. In addition, in terms of functionality, some of the individual modules included in one module may be included in the display device and others may be provided separately from the display device. For example, the display module 11 is included in the display device, whereas the processor 12, the memory 13, and the power module 14 are not included in the display device and are instead provided separately in the electronic device 10.

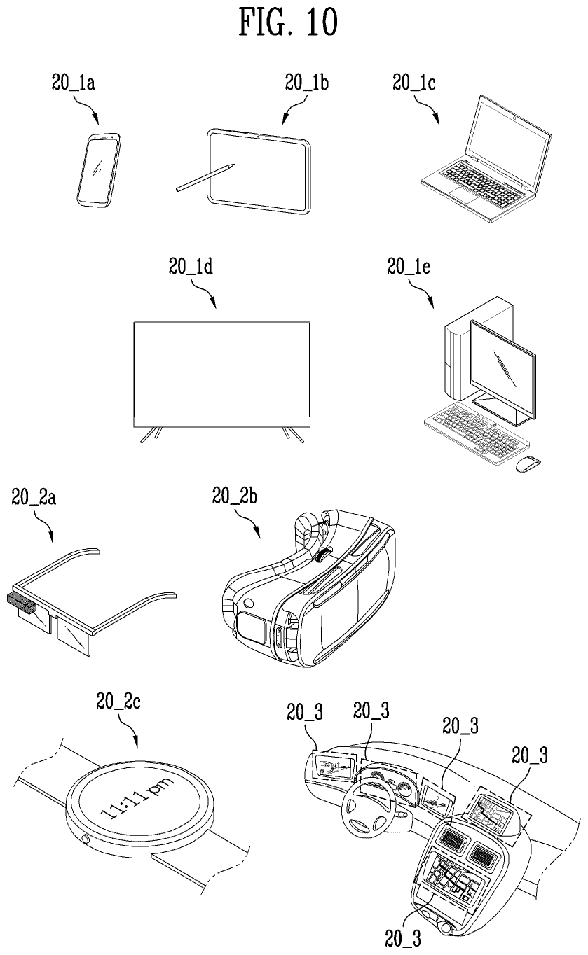

FIG. 10 shows schematic views of various embodiments of an electronic device.

Referring to FIG. 10, various types of electronic devices to which embodiments of a display device are applied may include an electronic device to display images such as a smartphone 10_1a, a tablet PC 10_1b, a laptop computer 10_1c, a television (TV) 10_1d, and a desktop monitor 10_1e, a wearable electronic device including a display module such as smart glasses 10_2a, a head-mounted display (HMD) 10_2b, and a smart watch 10_2c, and an automotive electronic device 10_3 including a display module such as a center information display (CID) disposed at the instrument cluster, the center fascia, and the dashboard of a vehicle, and a room mirror display.

Although the present disclosure been described in accordance with the above-described embodiments, it should be noted that the above-described embodiments are for illustrative purposes only and are not intended to limit the present disclosure. In addition, a person skilled in the art to which the present disclosure pertains will understand that various modifications are possible within the scope of the technical idea of the present disclosure.

What is claimed is:

1. A method of driving a display device comprising a display panel, a processor, and a first memory, the method comprising:
initializing the first memory upon power-on; and
organizing data in the first memory by providing a power-off notification (PON) command to the first memory.

2. The method according to claim 1, further comprising:
periodically storing data generated during operation of the display panel in the first memory by:
storing the data in the first memory;
the organizing the data in the first memory by providing a power-off notification (PON) command to the first memory; and
periodically repeating the storing of the data and the organizing of the data.

3. The method according to claim 2, further comprising periodically storing, in the first memory, accumulated data indicating driving time of pixels of the display panel.

4. The method according to claim 2, further comprising:
generating sensing data by sensing characteristics of pixels comprised in the display panel based on a signal for power-off being provided to the display device;
storing the sensing data in the first memory; and
providing the PON command to the first memory to organize the data in the first memory.

5. The method according to claim 4, further comprising storing, in a second memory of the display device, performance result information indicating whether the first memory has organized the data during a power-off procedure of the display device.

6. The method according to claim 5, further comprising reading the performance result information stored in the second memory.

7. The method according to claim 6, further comprising anticipating, with the processor, delay in initialization of the first memory based on the performance result information indicating that the first memory has organized the data not being read.

8. The method according to claim 1, wherein the providing a power-off notification (PON) command to the first memory to organize data in the first memory is performed, based on a signal for power-off being provided to the display device.

9. The method according to claim 8, wherein the organizing of the data in the first memory comprises:
generating sensing data by sensing characteristics of pixels of the display panel;
storing the sensing data in the first memory; and
providing the PON command to the first memory.

10. The method according to claim 8, further comprising storing, in a second memory of the display device, performance result information indicating whether the first memory has performed an operation of organizing the data.

11. The method according to claim 10, further comprising reading the performance result information stored in the second memory before initializing the first memory upon the power-on.

12. The method according to claim 11, further comprising anticipating, by the processor, delay in initialization of the first memory based on the performance result information indicating that the first memory has completed the operation of organizing the data not being read.

13. The method according to claim 5, wherein the first memory comprises an embedded MultiMedia Card (eMMC), and
wherein the second memory comprises an electrically erasable programmable read-only memory (EEPROM).

14. The method according to claim 1, further comprising performing, by the first memory, at least one of a data integrity check operation, a garbage collection operation, or a wear-leveling operation to initialize the first memory upon the power-on.

15. The method according to claim 14, wherein the first memory performs at least one of the data integrity check operation, the garbage collection operation, or the wear-leveling operation in response to the PON command.

16. A display device comprising:
a processor configured to output image data;
a display module configured to display an image based on the image data;
a first memory configured to store data generated during operation of the display module; and
a second memory,
wherein the processor is further configured to provide a power-off notification (PON) command to the first memory while the display module displays the image,
wherein the first memory is configured to be initialized upon power-on, and is configured to organize internal data in response to the PON command, and
wherein the second memory is configured to store performance result information indicating whether the first memory organized the internal data.

17. The display device according to claim 16, wherein the first memory comprises an embedded MultiMedia Card (eMMC), and
wherein the second memory comprises an electrically erasable programmable read-only memory (EEPROM).

18. The display device according to claim 17, wherein the first memory is configured to store accumulated data obtained by accumulating the image data, or to store sensing data obtained by sensing characteristics of a transistor in the display module, and
wherein the processor is configured to provide the PON command to the first memory based on completion of storage of the accumulated data or the sensing data in the first memory.

19. An electronic device comprising a display device comprising:
a processor configured to output image data;
a display module configured to display an image based on the image data;
a first memory configured to store data generated during operation of the display module; and
a second memory,
wherein the processor is further configured to provide a power-off notification (PON) command to the first memory while the display module displays the image,
wherein the first memory is configured to be initialized upon power-on, and is configured to organize internal data in response to the PON command, and
wherein the second memory is configured to store performance result information indicating whether the first memory organized the internal data.

20. The electronic device of claim 19, wherein the electronic device comprises a smartphone, a television, a monitor, a tablet, an electric vehicle, a mobile phone, a tablet personal computer (PC), a mobile communication terminal, an electronic notebook, an electronic book, a portable multimedia player (PMP), a navigation device, an ultra-mobile PC (UMPC), a laptop computer, a billboard, an Internet of Things (IoT) device, a smartwatch, a watch phone, or a head-mounted display (HMD).
